(19) United States
(12) Patent Application Publication
(10) Pub. No.: US 2026/0063583 A1
(43) Pub. Date: Mar. 5, 2026

(54) ELECTRODE AND ELECTROCHEMICAL MEASUREMENT SYSTEM

(71) Applicants: Murata Manufacturing Co., Ltd., Nagaokakyo-shi (JP); Ryukoku University, Kyoto-shi (JP)

(72) Inventors: Akira OSAKI, Nagaokakyo-shi (JP); Shuichi Kawata, Nagaokakyo-shi (JP); Yasuo Fujii, Nagaokakyo-shi (JP); Yoshifumi Aoi, Otsu-shi (JP); Megumi Kasuno, Otsu-shi (JP)

(21) Appl. No.: 19/381,288

(22) Filed: Nov. 6, 2025

Related U.S. Application Data
(63) Continuation of application No. PCT/JP2024/014423, filed on Apr. 9, 2024.

(30) Foreign Application Priority Data
May 11, 2023 (JP) 2023-078690

(51) Int. Cl. G01N 27/30; G01N 27/48

(52) U.S. Cl. CPC G01N 27/301; G01N 27/48

(57) ABSTRACT

An electrode that includes a carbon film having an sp² bond and an sp³ bond, the carbon film having a proportion of the sp³ bond of from 0.3 to 0.45 and a full width at half maximum of a G band of from 135 cm⁻¹ to 220 cm⁻¹.

### CROSS REFERENCE TO RELATED APPLICATIONS

The present application is a continuation of International application No. PCT/JP2024/014423, filed Apr. 9, 2024, which claims priority to Japanese Patent Application No. 2023-078690, filed May 11, 2023, the entire contents of each of which are incorporated herein by reference.

### TECHNICAL FIELD

The present disclosure relates to electrodes and electrochemical measurement systems.

### BACKGROUND ART

Stripping voltammetry is a known technique of electrochemical measurement. In the stripping voltammetry, metal ions contained at low concentrations in an aqueous solution are reduced and concentrated (i.e., the metal ions are deposited) on the surface of an electrode, and the reduced and concentrated metals are oxidatively dissolved. Based on the current value at the oxidative dissolution, the metal ions in the aqueous solution are measured with high sensitivity.

Patent Literature 1 discloses an electrode including a substrate and a conductive carbon layer disposed at one side in the thickness direction of the substrate and having an sp² bond and an sp³ bond, wherein the concentration ratio of oxygen to carbon is 0.07 or less on a one-side surface in the thickness direction of the conductive carbon layer.

According to the electrode disclosed in Patent Literature 1, for example, in stripping voltammetry, the metal to be measured can be sufficiently reduced and concentrated, and can be reliably oxidatively dissolved, thereby allowing the signal current to be increased. In cyclic voltammetry, the hydrogen peroxide to be measured can sufficiently be reduced at a lower potential, and thus the measurement sensitivity can be increased.
Patent Literature 1: JP 2021-56205 A

### SUMMARY OF THE DISCLOSURE

The metal detection characteristics of electrochemical measurement are influenced by the background current or signal current and the negative potential window in stripping voltammetry. Specifically, the metal detection sensitivity improves as the background current is lower and the signal current is higher, and the range of detectable metals broadens as the negative potential window widens in stripping voltammetry.

However, Patent Literature 1 does not mention the background current or signal current, or the negative potential window in stripping voltammetry. Therefore, there is room for improvement in terms of achieving the desired metal detection characteristics.

The present disclosure has been made to solve the above problem, and aims to provide an electrode that enables low background current and excellent metal detection sensitivity in stripping voltammetry. The present disclosure also aims to provide an electrochemical measurement system including the above electrode.

The electrode of the present disclosure includes a carbon film having an sp² bond and an sp³ bond, and the carbon film has a proportion of the sp³ bond of from 0.3 to 0.45 and a full width at half maximum of a G-band of from 135 cm⁻¹ to 220 cm⁻¹.

The electrochemical measurement system of the present disclosure includes the electrode of the present disclosure.

The present disclosure can provide an electrode that enables low background current and excellent metal detection sensitivity in stripping voltammetry. The present disclosure can also provide an electrochemical measurement system including the above electrode.

### BRIEF DESCRIPTION OF THE DRAWINGS

FIG. 1 is a cross-sectional view schematically illustrating an embodiment of the electrode of the present disclosure.

FIG. 2 is a schematic diagram showing an example of the electrochemical measurement system of the present disclosure.

FIG. 3 shows a C1s spectrum obtained by XPS in Example 1.

FIG. 4 shows a Raman spectrum obtained by Raman spectroscopy in Example 1.

FIG. 5 shows SV curves of lead in Example 1.

FIG. 6 is a graph showing the concentration dependence of the oxidation current of lead in Example 1.

FIG. 7 shows SV curves of zinc in Example 8.

### DESCRIPTION OF THE PREFERRED EMBODIMENTS

Hereinafter, the electrode and the electrochemical measurement system of the present disclosure will be described.

However, the present disclosure is not limited to the following embodiments, and can be suitably modified and applied within the scope that does not alter the gist of the disclosure. The present disclosure also encompasses combinations of two or more desirable configurations of the present disclosure described in the following embodiments.

The drawings shown below are schematic diagrams, and their dimensions and aspect ratio scales may differ from those of the actual products.

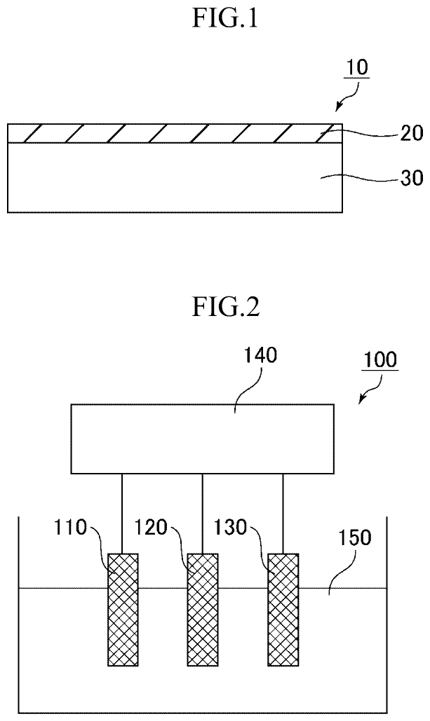

FIG. 1 is a cross-sectional view schematically illustrating an embodiment of the electrode of the present disclosure.

An electrode 10 in FIG. 1 includes a carbon film 20. As illustrated in FIG. 1, the electrode 10 preferably further includes an underlying substrate 30. In such a case, the carbon film 20 is disposed on one main surface of the underlying substrate 30.

The carbon film 20 is formed from carbon having sp² bonds and sp³ bonds. In other words, the carbon film 20 is a film having a graphite structure and a diamond structure. The carbon film 20 therefore exhibits good electrical conductivity.

In the carbon film 20 in the electrode 10, the proportion of sp³ bonds is from 0.3 to 0.45 and the full width at half maximum of the G band is from 135 cm⁻¹ to 220 cm⁻¹.

The proportion of sp³ bonds in the carbon film 20 refers to the ratio of the number of sp³-bonded atoms to the sum of the number of sp²-bonded atoms and the number of sp³-bonded atoms (sp³/(sp²+sp³)). The proportion of sp³ bonds in the carbon film 20 can be calculated by determining the peak areas of sp² bonds and sp³ bonds from the C1s spectrum obtained by performing X-ray photoelectron spectroscopy (XPS) on the carbon film 20.

The full width at half maximum (FWHM) of the G band in the carbon film 20 is used as an indicator of the degree of crystallinity. The higher the full width at half maximum of the G band, the lower the degree of crystallinity, and the lower the full width at half maximum of the G band, the higher the degree of crystallinity. The full width at half maximum of the G band in the carbon film 20 can be calculated by performing peak separation into the G band and D band from the Raman spectrum obtained by performing Raman spectroscopy on the carbon film 20.

With the carbon film 20 where the proportion of sp³ bonds is from 0.3 to 0.45 and the full width at half maximum of the G band is from 135 cm⁻¹ to 220 cm⁻¹, the background current is low and excellent metal detection sensitivity can be achieved in stripping voltammetry.

The background current in stripping voltammetry arises from the desorption of water molecules and other substances. Since the π electrons of sp²-bonded carbon serve as adsorption sites, it is considered that a film structure with a higher proportion of sp³ bonds and fewer π electrons can reduce the background current.

If the proportion of sp³ bonds in the carbon film 20 is too high, the electrical conductivity of the carbon film 20 decreases, and such a carbon film 20 is difficult to serve as an electrode. Also, if the proportion of sp³ bonds in the carbon film 20 is too high, the internal stress of the carbon film 20 increases, and the carbon film 20 is likely to peel off from the underlying substrate 30.

If the full width at half maximum of the G band in the carbon film 20 is too high, the electrical conductivity of the carbon film 20 decreases, and such a carbon film 20 on the substrate 30 is difficult to serve as an electrode. Moreover, if the full width at half maximum of the G band in the carbon film 20 is too high, the crystallite size (La) is three times or less the carbon-carbon bond length (0.14 nm) of the six-membered ring of carbon, and such a carbon film 20 cannot be defined as having nano-sized crystals.

In the electrode 10, preferably, the proportion of sp³ bonds is from 0.3 to 0.42 and the full width at half maximum of the G band is from 135 cm⁻¹ to 210 cm⁻¹ in the carbon film 20.

With the carbon film 20 where the proportion of sp³ bonds is from 0.3 to 0.42 and the full width at half maximum of the G band is from 135 cm⁻¹ to 210 cm⁻¹, the signal current is high and excellent metal detection sensitivity can be achieved in stripping voltammetry.

The oxidation current is proportional to the electrode area where reduction and concentration are active in stripping voltammetry. Since the exposed surface area of highly reactive sp²-bonded carbon corresponds to the area for reduction and concentration, it is believed that a film structure with a relatively high proportion of sp² bonds can increase the signal current.

In the electrode 10, more preferably, the proportion of sp³ bonds is from 0.34 to 0.37 and the full width at half maximum of the G band is from 185 cm⁻¹ to 210 cm⁻¹ in the carbon film 20.

With the carbon film 20 where the proportion of sp³ bonds is from 0.34 to 0.37 and the full width at half maximum of the G band is from 185 cm⁻¹ to 210 cm⁻¹, the negative potential window is wide and the number of detectable metal species is large.

The negative potential window refers to the potential at which the reduction reaction of water occurs and relates to the ease of electron donation from the electrode to water molecules. Since carriers in conductive carbon materials originate from clusters formed by sp² bonds, when these clusters are small and thus the number of electron carriers is small, electron donation is less likely to occur, resulting in a wider negative potential window.

When the negative potential window is wide, the reduction and concentration of metals with large reduction potential such as zinc are less likely to compete with the reduction reaction of water. This is believed to enable highly reproducible detection.

The carbon film 20 may have any thickness. From the standpoint of film formation, the thickness of the carbon film 20 is preferably 5 nm or more, more preferably 10 nm or more. From the standpoint of thin film formation and ease of handling, the thickness of the carbon film 20 is preferably 500 nm or less, more preferably 300 nm or less, still more preferably 200 nm or less.

The thickness of the carbon film 20 can be calculated by measuring the X-ray reflectivity of the carbon film 20. For measuring the X-ray reflectivity, a multipurpose X-ray diffractometer SmartLab (Rigaku Corporation) can be used, for example.

The carbon film 20 may contain additives other than carbon, including other elements. The carbon film 20 may include multiple layers that differ in structure, composition, additive concentration, and the like. Alternatively, the carbon film 20 may have a configuration in which the structure, composition, additive concentration, and the like vary gradually.

When the electrode 10 includes the underlying substrate 30, the underlying substrate 30 is in the form of a sheet or a film. The underlying substrate 30 supports the carbon film 20.

Examples of the underlying substrate 30 include inorganic base materials and organic substrates.

Examples of inorganic substrates include silicon substrates and glass substrates.

Examples of organic substrates include polymer films. Examples of the materials for polymer films include polyester resins (such as polyethylene terephthalate, polyethylene naphthalate), acetate resins, polyether sulfone resins, polycarbonate resins, polyamide resins, polyimide resins, polyolefin resins (such as polycycloolefin polymers), (meth)acrylic resins, polyvinyl chloride resins, polyvinylidene chloride resins, polystyrene resins, polyvinyl alcohol resins, polyarylate resins, and polyphenylene sulfide resins.

The underlying substrate 30 preferably has electrical conductivity. Examples of the underlying substrate 30 having electrical conductivity include conductive inorganic substrates such as conductive silicon substrates.

The carbon film 20 having a film structure suitable for metal detection has low electrical conductivity in some cases. Even in such a case, when a conductive substrate is used as the underlying substrate 30, it becomes possible to draw the current generated by electrochemical reaction on the surface of the carbon film 20 through the underlying substrate 30, allowing for use as an electrode.

If the resistance of the carbon film and/or the resistance of the underlying substrate are high in the electrode, an IR drop occurs. This causes the potential at the electrode surface to be lower than the applied potential. As a result, the oxidation potential may appear to shift toward a higher potential. It is therefore preferable that the oxidation potential of the reactant in cyclic voltammetry does not shift toward a higher potential due to the IR drop upon drawing of the current.

Here, the term “electrical conductivity” means, for example, that the volume resistivity is less than 0.02 Ω·cm.

The underlying substrate 30 may have any thickness. The thickness is for example, 2 μm or more, preferably 20 μm or more, while it is, for example, 1000 μm or less, preferably 500 μm or less.

The electrode 10 in FIG. 1 consists of the carbon film 20 and the underlying substrate 30. Still, it may further include one or more functional layers between the carbon film 20 and the underlying substrate 30, or on the other main surface of the underlying substrate 30. Examples of functional layers include gas barrier layers, conductive layers, adhesion layers, and surface smoothing layers.

A method for producing the electrode 10 in FIG. 1 includes, for example, a step of providing the underlying substrate 30 and a step of forming the carbon film 20 on one main surface of the underlying substrate 30.

The step of providing the underlying substrate 30 includes, for example, providing a known or commercially available substrate. If necessary, treatment such as pretreatment or cleaning treatment may be performed on the one main surface of the provided substrate.

The step of forming the carbon film 20 includes forming the carbon film 20 on one main surface of the underlying substrate 30.

The film formation process is selected to control the structure of the carbon film 20 and is not limited. Examples thereof include pulse laser deposition (PLD), chemical vapor deposition (CVD), sputtering, paste printing using carbon materials, and carbonization of various organic materials (e.g., polyimide, liquid crystal polymer, epoxy, lignin, polyamide, phenolic resin).

The electrode of the present disclosure can be used as various types of electrodes. The electrode of the present disclosure is preferably used as an electrode for electrochemical measurement, specifically as a working electrode for stripping voltammetry.

On one main surface of the electrode of the present disclosure, an insulating layer patterned into a desired shape may be provided in order to adjust the exposed surface of the carbon film (electrode surface). Alternatively, the entire electrode or the carbon film may be patterned into a desired shape. Examples of the insulating layer include polymer films mentioned above for the underlying substrate.

Hereinbelow, an electrochemical measurement system including the electrode of the present disclosure will be described in detail. The present disclosure also encompasses such an electrochemical measurement system.

The electrochemical measurement system of the present disclosure includes, for example, a working electrode, a reference electrode, a potentiometer for measuring the electromotive force between these electrodes, and an aqueous solution (electrolyte). The electrode of the present disclosure is preferably used as a working electrode.

FIG. 2 is a schematic diagram illustrating an example of the electrochemical measurement system of the present disclosure.

An electrochemical measurement system 100 in FIG. 2 includes a working electrode 110, a reference electrode 120, a counter electrode 130, a potentiostat 140 that controls the potentials of these electrodes, an ammeter (not shown as it is incorporated into the potentiostat 140) that measures the current flowing between the working electrode 110 and the counter electrode 130, and an aqueous solution 150.

Examples of the working electrode 110 include the electrode of the present disclosure such as the electrode 10 in FIG. 1.

Examples of the reference electrode 120 include a silver/silver chloride electrode, a saturated calomel electrode, and a standard hydrogen electrode.

Examples of the counter electrode 130 include a platinum electrode, a gold electrode, and a nickel electrode.

Examples of the aqueous solution 150 include an aqueous solution containing a subject to be measured.

In the electrochemical measurement system 100 in FIG. 2, stripping voltammetry is performed using the electrode of the present disclosure as the working electrode 110, for example.

Subjects to be measured in stripping voltammetry are metal ions. Examples of metal ions include heavy metal ions such as iron ions, lead ions, gold ions, platinum ions, silver ions, copper ions, chromium ions, cadmium ions, mercury ions, zinc ions, arsenic ions, manganese ions, cobalt ions, nickel ions, molybdenum ions, tungsten ions, tin ions, bismuth ions, uranium ions, and plutonium ions.

As described above, in the electrode of the present disclosure, the proportion of sp³ bonds is from 0.3 to 0.45 and the full width at half maximum of the G band is from 135 cm⁻¹ to 220 cm⁻¹ in the carbon film. Therefore, the background current is low and the metal detection sensitivity is excellent in stripping voltammetry.

### EXAMPLES

Examples more specifically disclosing the electrode of the present disclosure are shown below. Still, the present disclosure is not limited only to these examples.

### Example 1

### [Formation of Carbon Film]

A 200-nm-thick carbon film was formed on a 350-μm-thick conductive silicon substrate by pulsed laser deposition (PLD). PLD involves irradiation of a graphite target placed inside a chamber with a pulsed laser to cause the target to vaporize instantaneously and generate a plume. Active particles in the plume reach the substrate and re-condense to form a carbon film.

The film structure of the carbon film can be controlled by the conditions for PLD. Specifically, the film structure (degree of crystallinity and the proportion of sp³ bonds) of the carbon film can be controlled by adjusting the film formation conditions to vary the ejection behavior of carbon atoms and their energy upon reaching the substrate.

The conditions in the present example are as follows.
Target material: graphite
Laser wavelength: Nd:YAG laser (266 nm)
Laser density: 2.54 J/cm²
Repetition frequency: 10 Hz
Film formation atmosphere: vacuum (2.0×10⁻⁷ Torr)
Substrate temperature: 400° C.

### [Evaluation of Film Structure of Carbon Film]

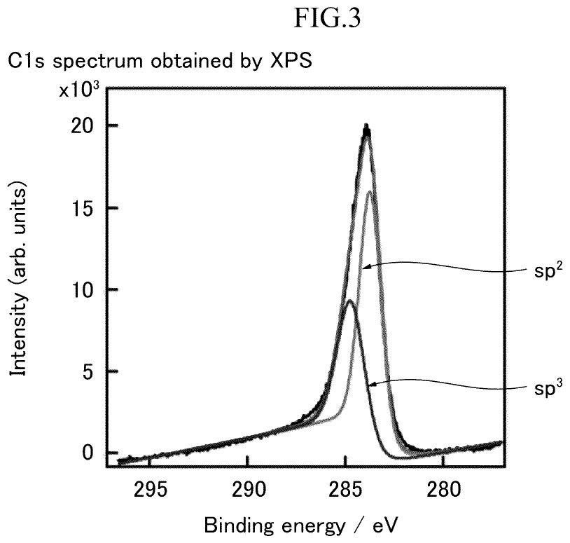

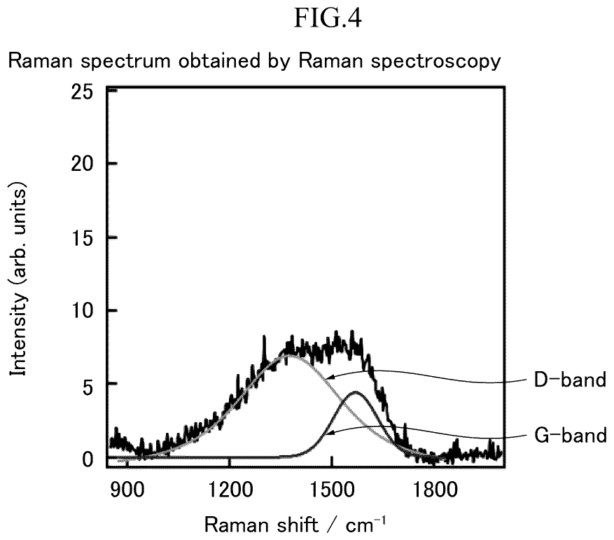

X-ray photoelectron spectroscopy (XPS) was performed on this carbon film.
FIG. 3 shows a C1s spectrum obtained by XPS in Example 1.
From the obtained C1s spectrum, the peak areas of sp² bonds and sp³ bonds were determined, and the proportion of sp³ bonds was calculated. In Example 1, the proportion of sp³ bonds was 0.32.
Next, Raman spectroscopy was performed.
FIG. 4 shows a Raman spectrum obtained by Raman spectroscopy in Example 1.
Based on the obtained Raman spectrum, peak separation into the G-band and the D-band was performed, and the full width at half maximum (FWHM) of the G-band, which is an indicator of the degree of crystallinity, was calculated. In Example 1, the FWHM of the G-band was 136 cm⁻¹. The cluster size La due to sp² bonds was assumed to be approximately 1.5 nm, indicating that the carbon film contains amorphous carbon having nano-sized crystals.
The measurement conditions and analysis conditions are as follows.

### [XPS]

Measurement device: X-ray photoelectron spectrometer PHI XPS-1600R (ULVAC, Inc.)
X-ray source: Mg Kα (1253.6 eV), 15 kV, 400 W
Take-off angle: 45 degrees
Measurement area: 800 μm
Analysis conditions: Baseline subtraction by Shirley method and peak separation by Voigt function (Gauss 0.7, Lorentz 0.3)

### [Raman Spectroscopy]

Measurement device: Fluorescence-rejection laser Raman spectrophotometer RMP-510RS (JASCO Corporation)
Light source: Nd:YVO₄ semiconductor laser (532 nm), 20 mW Grating: 900 gr/mm
Measurement area: 20× magnification, working distance 12 mm, numerical aperture 0.40
Analysis conditions: Baseline subtraction by linear function and peak separation by Gaussian function

### [Evaluation of Lead Detection Characteristics of Carbon Film]

The present carbon film as the working electrode, silver/silver chloride as the reference electrode, and a platinum wire as the counter electrode were set in an electrochemical measurement cell (plate material evaluating cell kit, BAS Inc.). An acetate buffer solution (pH 5.6) containing lead chloride was poured so that the electrodes were immersed therein, and the cell was connected to a potentiostat (Model 600E, BAS Inc.).

The solutions were prepared such that the concentration of lead ions was adjusted to 1×10⁻⁷ M, 5×10⁻⁷ M, 1×10⁻⁶ M, and 2× 10⁻⁶ M, and stripping voltammetry (SV) was performed for each solution. Specifically, first, a voltage was applied to the carbon film with a reduction potential set to −1.4 V and a deposition time set to 300 seconds, whereby lead ions in the low-concentration aqueous lead chloride solution were reduced and concentrated on the surface of the carbon film. Next, linear sweep voltammetry was performed with the sweep speed set to 200 mV/s, and the concentrated lead was oxidatively dissolved.

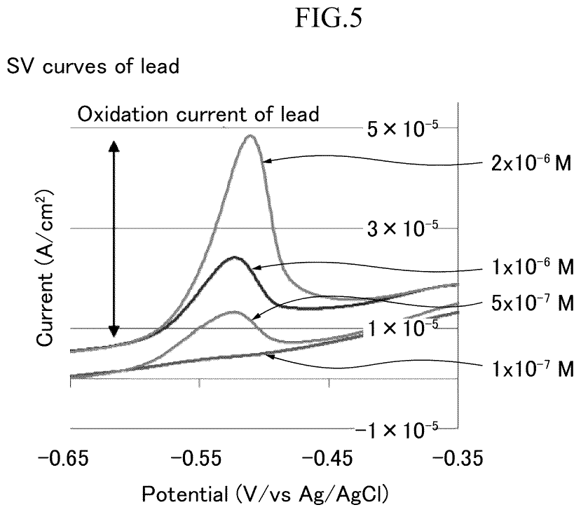

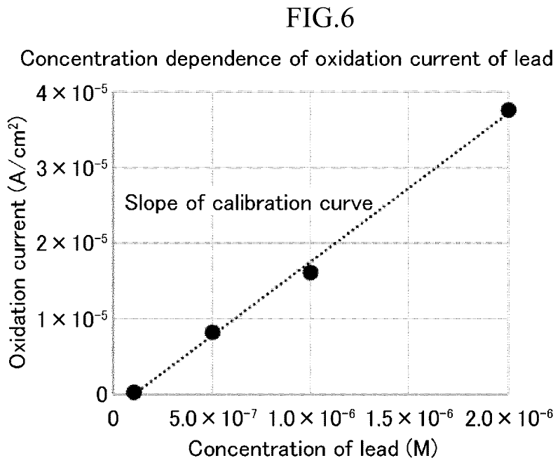

FIG. 5 shows SV curves of lead in Example 1. FIG. 6 is a graph showing the concentration dependence of the oxidation current of lead in Example 1.

In Example 1, the background current (BG current) in SV was 25 μA/cm², and the slope of the calibration curve for lead was 19 μA/μM·cm². The current value at 0 V in the SV curve was defined as the BG current in SV.

### Example 2

An electrode was produced under the same conditions as those in Example 1, except that the substrate temperature was changed to room temperature (R.T.). The evaluation of the film structure and the evaluation of lead detection characteristics were performed as in Example 1.

### Example 3

An electrode was produced under the same conditions as those in Example 1, except that the atmosphere was changed to a nitrogen atmosphere (1.0×10⁻² Torr). The evaluation of the film structure and the evaluation of lead detection characteristics were performed as in Example 1.

### Comparative Example 1

An electrode was produced under the same conditions as those in Example 1, except that the atmosphere was changed to an argon atmosphere (1.0×10⁻² Torr). The evaluation of the film structure and the evaluation of lead detection characteristics were performed as in Example 1.

### Comparative Example 2

A 70-μm-thick carbon film was formed on a 125-μm-thick polyimide film by a laser carbonization method. Laser carbonization is a phenomenon where organic materials such as resins are transformed into a graphite structure by laser energy.

The film structure of the carbon film can be controlled by laser irradiation conditions. Specifically, the film structure (degree of crystallinity and proportion of sp³ bonds) of the carbon film can be controlled by varying the laser wavelength to change the amount of heat applied to the surface of resin such as polyimide. The laser carbonization method enables production of a carbon film with a high degree of crystallinity that is difficult to form by the PLD method.

The conditions in Comparative Example 2 are as follows. After the production, the film structure evaluation and the evaluation of lead detection characteristics were performed in the same manner as in Example 1.
Irradiation material: Kapton R (Du Pont-Toray Co., Ltd.)
Laser device: 3Axis-CO₂ laser marker/head ML-Z9510 (Keyence Corporation)
Laser wavelength: 10.6 μm
Laser power: 6 W
Atmosphere: ambient air
Sweep speed: 250 mm/s
Sweep interval: 100 μm

### Comparative Example 3

Using a laser carbonization method, a 50-μm-thick carbon film was formed on a 125-μm-thick polyimide film. A laser wavelength different from that in Comparative Example 2 was used to control the film structure.

The conditions in Comparative Example 3 are as follows. After the production, the film structure evaluation and the evaluation of lead detection characteristics were performed in the same manner as in Example 1.
Irradiation material: Kapton R (Du Pont-Toray Co., Ltd.)
Laser device: 3-Axis Hybrid Laser Marker MD-X1000 (Keyence Corporation)
Laser wavelength: 1064 nm
Laser power: 5 W
Atmosphere: ambient air
Sweep speed: 250 mm/s
Sweep interval: 25 μm

Table 1 collectively shows the film formation conditions, the indicators of film structure, and the lead detection characteristics in Examples 1 to 3 and Comparative Examples 1 to 3. In Table 1, carbon films for which no oxidation current of lead could be detected are marked with “-”

TABLE 1

| | | | | | Lead detection characteristics | |
|---|---|---|---|---|---|---|
| | | | Film structure | | | Slope of |
| | Film formation process | | Proportion of | FWHM of G | BG current in | calibration curve |
| | Method | Condition | sp³ bonds | band (cm⁻¹) | SV (μA/cm²) | (μA/μM · cm²) |
| Example 1 | PLD | Laser density: 2.54 J/cm² | 0.32 | 136 | 25 | 19 |
| | | Substrate temperature: 400° C. | | | | |
| | | Atmosphere: vacuum | | | | |
| Example 2 | | Laser density: 2.54 J/cm² | 0.45 | 215 | 10 | 6.0 |
| | | Substrate temperature: R.T. | | | | |
| | | Atmosphere: vacuum | | | | |
| Example 3 | | Laser density: 2.54 J/cm² | 0.38 | 143 | 54 | 15 |
| | | Substrate temperature: 400° C. | | | | |
| | | Atmosphere: nitrogen | | | | |
| Comparative | | Laser density: 2.54 J/cm² | 0.25 | 130 | 210 | — |
| Example 1 | | Substrate temperature: 400° C. | | | | |
| | | Atmosphere: argon | | | | |
| Comparative | Laser | Laser wavelength: 10.6 μm | 0.34 | 84 | 560 | — |
| Example 2 | carbonization | Laser power: 6 W | | | | |
| | | Sweep speed: 250 mm/s | | | | |
| Comparative | | Laser wavelength: 1064 nm | 0.33 | 23 | 140 | — |
| Example 3 | | Laser power: 5 W | | | | |
| | | Sweep speed: 250 mm/s | | | | |

In Examples 1 to 3, the BG currents in SV were one order of magnitude smaller than those in SV in Comparative Examples 1 to 3, and the oxidation current of lead was confirmed. Therefore, if the proportion of sp³ bonds is from 0.3 to 0.45 and the FWHM of the G band is from 135 cm⁻¹ to 220 cm⁻¹ in the carbon film, the detection sensitivity is considered to be high and the carbon film is suitable for metal detection.

As described above, the BG current in SV is caused by, for example, the desorption of water molecules. Since the π electrons of sp²-bonded carbon serve as adsorption sites, it is considered that the film structure with fewer π electrons, where the proportion of sp³ bonds is increased and the degree of crystallinity is reduced, can reduce the BG current.

### Example 4

An electrode was produced under the same conditions as those in Example 2, except that the laser density was changed to 3.57 J/cm². The evaluation of the film structure and the evaluation of lead detection characteristics were performed as in Example 1.

### Example 5

After the film formation under the same conditions as those in Example 2, annealing treatment was performed in the same chamber (substrate temperature: 400° C., atmosphere: vacuum (2.0×10⁻⁷ Torr), duration: 1 hour), whereby an electrode was produced. The evaluation of the film structure and the evaluation of lead detection characteristics were performed as in Example 1.

### Example 6

After the film formation under the same conditions as those in Example 3, except that the substrate temperature was changed to room temperature (R.T.), annealing treatment was performed in the same chamber (substrate temperature: 400° C., atmosphere: vacuum (2.0×10⁻⁷ Torr), duration: 1 hour), whereby an electrode was produced. The evaluation of the film structure and the evaluation of lead detection characteristics were performed as in Example 1.

### Example 7

After the film formation under the same conditions as those in Comparative Example 1, except that the substrate temperature was changed to room temperature (R.T.), annealing treatment was performed in the same chamber (substrate temperature: 400° C., atmosphere: vacuum (2.0×10⁻⁷ Torr), duration: 1 hour), whereby an electrode was produced. The evaluation of the film structure and the evaluation of lead detection characteristics were performed as in Example 1.

Table 2 collectively shows the film formation conditions, the indicators of film structure, and the lead detection characteristics in Examples 1 to 7.

TABLE 2

| | | | | | | Lead detection characteristics | |
|---|---|---|---|---|---|---|---|
| | | | | Film structure | | | Slope of |
| | Film formation process | | | Proportion of | FWHM of G | BG current in | calibration curve |
| | Method | Condition | Annealing | sp³ bonds | band (cm⁻¹) | SV (μA/cm²) | (μA/μM · cm²) |
| Example 1 | PLD | Laser density: 2.54 J/cm² | Not | 0.32 | 136 | 25 | 19 |
| | | Substrate temperature: 400° C. | performed | | | | |
| | | Atmosphere: vacuum | | | | | |
| Example 2 | | Laser density: 2.54 J/cm² | Not | 0.45 | 215 | 10 | 6.0 |
| | | Substrate temperature: R.T. | performed | | | | |
| | | Atmosphere: vacuum | | | | | |
| Example 3 | | Laser density: 2.54 J/cm² | Not | 0.38 | 143 | 54 | 15 |
| | | Substrate temperature: 400° C. | performed | | | | |
| | | Atmosphere: nitrogen | | | | | |
| Example 4 | | Laser density: 3.57 J/cm² | Not | 0.35 | 205 | 6.9 | 22 |
| | | Substrate temperature: R.T. | performed | | | | |
| | | Atmosphere: vacuum | | | | | |
| Example 5 | | Laser density: 2.54 J/cm² | Performed | 0.45 | 172 | 7.7 | 9.3 |
| | | Substrate temperature: R.T. | | | | | |
| | | Atmosphere: vacuum | | | | | |
| Example 6 | | Laser density: 2.54 J/cm² | Performed | 0.42 | 181 | 16 | 19 |
| | | Substrate temperature: R.T. | | | | | |
| | | Atmosphere: nitrogen | | | | | |
| Example 7 | | Laser density: 2.54 J/cm² | Performed | 0.32 | 172 | 7.7 | 19 |
| | | Substrate temperature: R.T. | | | | | |
| | | Atmosphere: argon | | | | | |

The values of the slopes of the calibration curves for lead in Examples 1, 3, 4, 6, and 7 were 1.5 times or more the values of the slopes of the calibration curves for lead in Examples 2 and 5. Therefore, if the proportion of sp³ bonds is from 0.3 to 0.42 and the FWHM of the G-band is from 135 cm⁻¹ to 210 cm⁻¹ in the carbon film, the detection sensitivity is considered to be higher and the electrode is suitable for metal detection.

As described above, the oxidation current is proportional to the electrode area where the reduction and concentration are active in SV. Since the exposed surface areas of highly reactive sp²-bonded carbon correspond to the area for reduction and concentration, it is believed that a film structure containing a large amount of sp²-bonded carbon can increase the slope of the calibration curve.

### Example 8

An electrode was produced under the same conditions as those in Example 2, except that the laser density was changed to 2.65 J/cm². In addition to the evaluation of the film structure and the lead detection characteristics, which were the same as in Example 1, the zinc detection characteristics were evaluated as follows.

### [Evaluation of Zinc Detection Characteristics of Carbon Film]

The zinc detection characteristics were evaluated using the same setup as that for the evaluation of the lead detection characteristics in Example 1. Detection of metals with large reduction potentials, such as zinc, requires setting the reduction potential in SV to a more negative value, which is likely to cause competition with the water reduction reaction and reduced reproducibility. Therefore, the width of the negative potential window and the reproducibility of the oxidation current of zinc were evaluated. A wider negative potential window is less affected by water reduction reaction.

The evaluation of the potential window was carried out by cyclic voltammetry at a sweep speed of 50 mV/s in 0.05 M sulfuric acid. A negative potential at which the current density reaches 5×10⁻⁴ A/cm² was defined as the negative potential window. In evaluation of the reproducibility of the oxidation current of zinc, the aqueous solution was prepared to a zinc ion concentration of 1×10⁻⁵ M and stripping voltammetry (SV) was performed three times. The evaluation was performed as in Example 1, except that the reduction potential was changed to −2.0 V.

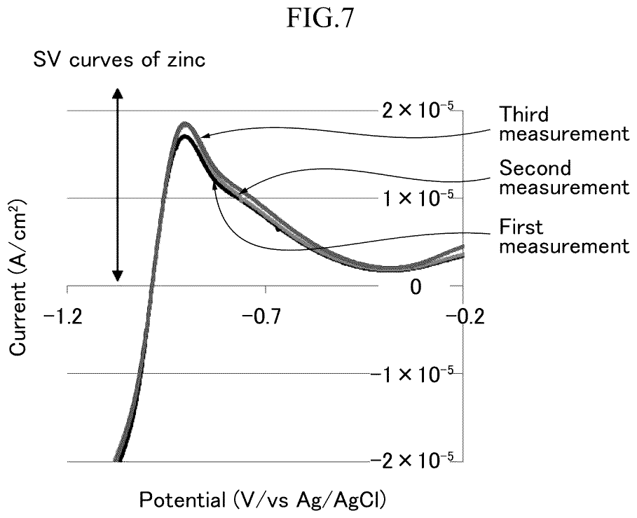

FIG. 7 shows SV curves of zinc in Example 8.

In Example 8, the negative potential window was-1.4 V and the oxidation currents of zinc measured three times were 47 μA/cm², 50 μA/cm², and 50 μA/cm², which shows that the measurement was highly reproducible.

### Example 9

An electrode was produced under the same conditions as those in Example 2, except that the film formation chamber was changed and the laser density was changed to 0.91 J/cm². In addition to the evaluation of the film structure and the lead detection characteristics, which were the same as in Example 1, the zinc detection characteristics as in Example 8 were also evaluated.

For Examples 1, 3, 4, 6, and 7, the same evaluation of zinc detection characteristics as in Example 8 was added. Table 3 collectively shows the film formation conditions, the indicators of film structure, and the lead detection characteristics. The criteria for highly reproducible detection of zinc were as follows.
∘(Good): Variation within 5% from the average value of the oxidation current measured three times.
x (Poor): Variation of 5% or more from the average value of the oxidation current measured three times, or no oxidation current detected.

TABLE 3

| | | | | Film structure | |
|---|---|---|---|---|---|
| | | | | | FWHM of |
| | Film formation process | | | Proportion | G band |
| | Method | Condition | Annealing | of sp³ bonds | (cm⁻¹) |
| Example 1 | PLD | Laser density: 2.54 J/cm² | Not | 0.32 | 136 |
| | | Substrate temperature: 400° C. | performed | | |
| | | Atmosphere: vacuum | | | |
| Example 3 | | Laser density: 2.54 J/cm² | Not | 0.38 | 143 |
| | | Substrate temperature: 400° C. | performed | | |
| | | Atmosphere: nitrogen | | | |
| Example 4 | | Laser density: 3.57 J/cm² | Not | 0.35 | 205 |
| | | Substrate temperature: R.T. | performed | | |
| | | Atmosphere: vacuum | | | |
| Example 6 | | Laser density: 2.54 J/cm² | Performed | 0.42 | 181 |
| | | Substrate temperature: R.T. | | | |
| | | Atmosphere: nitrogen | | | |
| Example 7 | | Laser density: 2.54 J/cm² | Performed | 0.32 | 172 |
| | | Substrate temperature: R.T. | | | |
| | | Atmosphere: argon | | | |
| Example 8 | | Laser density: 2.65 J/cm² | Not | 0.34 | 200 |
| | | Substrate temperature: R.T. | performed | | |
| | | Atmosphere: vacuum | | | |
| Example 9 | | Laser density: 0.91 J/cm² | Performed | 0.37 | 185 |
| | | Substrate temperature: R.T. | | | |
| | | Atmosphere: vacuum | | | |
| | | (chamber was changed) | | | |

| | Lead detection characteristics | | Zinc detection characteristics | |
|---|---|---|---|---|
| | | Slope of calibration | Negative potential | |
| | BG current in SV | curve | window | Highly reproducible |
| | (μA/cm²) | (μA/μM · cm²) | (V) | detection |
| Example 1 | 25 | 19 | −1.0 | X |
| Example 3 | 54 | 15 | −0.9 | X |
| Example 4 | 6.9 | 22 | −1.5 | ◯ |
| Example 6 | 16 | 19 | −0.9 | X |
| Example 7 | 7.7 | 19 | −0.9 | X |
| Example 8 | 8.4 | 27 | −1.4 | ◯ |
| Example 9 | 11 | 24 | −1.2 | ◯ |

In Examples 4, 8, and 9, the negative potential window was wider by 0.2 V or more than that in Examples 1, 3, 6, and 7, and detection of zinc was highly reproducible. Therefore, if the proportion of sp³ bonds is from 0.34 to 0.37 and the FWHM of the G band is from 185 cm⁻¹ to 210 cm⁻¹ in the carbon film, the range of detectable metal species is broader and the electrode is suitable for metal detection.

As described above, the negative potential window refers to the potential at which the reduction reaction of water occurs and relates to the ease of electron donation from the electrode to the water molecules. Since carriers in conductive carbon materials originate from clusters formed by sp² bonds, when these clusters are small and thus the number of electron carriers is small, electron donation is less likely to occur, resulting in a wider negative potential window. Moreover, when the negative potential window is wide, the reduction and concentration of metals with high reduction potentials such as zinc are less likely to compete with the reduction reaction of water, thereby ensuring reproducibility.

### Example 10

An electrode was produced under the same conditions as those in Example 8, except that the underlying substrate was changed to a polyimide film (Kapton R, Du Pont-Toray Co., Ltd.). When the film structure is evaluated as in Example 1, the structure was similar to that in Example 8 where the underlying substrate was a conductive silicon substrate. However, the electrochemical measurement was difficult as the electrode resistance was high.

From the above, as in Examples 1 to 9, a carbon film formed on a conductive underlying substrate can be used as an electrode for electrochemical measurement even when the carbon film is thin. When the electrical conductivity of the carbon film is low, using a 200-nm-thick carbon film alone results in a high electrode resistance, making it difficult to use such a carbon film alone as an electrode for electrochemical measurement. When a conductive substrate is used as the underlying substrate, it becomes possible to draw the current generated by electrochemical reaction on the surface of the carbon film through the underlying substrate, enabling use of the carbon film on the substrate as an electrode.

### REFERENCE SIGNS LIST

10: electrode
20: carbon film
30: underlying substrate
100: electrochemical measurement system
110: working electrode
120: reference electrode
130: counter electrode
140: potentiostat
150: aqueous solution

1. An electrode comprising:
a carbon film having an sp² bond and an sp³ bond,
the carbon film having a proportion of the sp³ bond of from 0.3 to 0.45 and a full width at half maximum of a G-band of from 135 cm⁻¹ to 220 cm⁻¹.

2. The electrode according to claim 1, wherein the proportion of the sp³ bond is from 0.3 to 0.42.

3. The electrode according to claim 1, wherein the full width at half maximum of the G band is from 135 cm⁻¹ to 210 cm⁻¹.

4. The electrode according to claim 1, wherein, in the carbon film, the proportion of the sp³ bond is from 0.3 to 0.42 and the full width at half maximum of the G band is from 135 cm⁻¹ to 210 cm⁻¹.

5. The electrode according to claim 1, wherein the proportion of the sp³ bond is from 0.34 to 0.37.

6. The electrode according to claim 1, wherein the full width at half maximum of the G band is from 185 cm⁻¹ to 210 cm⁻¹.

7. The electrode according to claim 1, wherein, in the carbon film, the proportion of the sp³ bond is from 0.34 to 0.37 and the full width at half maximum of the G band is from 185 cm⁻¹ to 210 cm⁻¹.

8. The electrode according to claim 1, wherein a thickness of the carbon film is from 5 nm to 500 nm.

9. The electrode according to claim 1, wherein a thickness of the carbon film is from 10 nm to 300 nm.

10. The electrode according to claim 1, further comprising:
an underlying substrate,
wherein the carbon film is on a surface of the underlying substrate.

11. The electrode according to claim 10, wherein the underlying substrate has electrical conductivity.

12. The electrode according to claim 10, wherein the underlying substrate includes a conductive inorganic substrate.

13. The electrode according to claim 10, wherein the underlying substrate includes a conductive silicon substrate.

14. The electrode according to claim 10, wherein a thickness of the underlying substrate is from 2 μm to 1000 μm.

15. The electrode according to claim 10, wherein a thickness of the underlying substrate is from 20 μm to 500 μm.

16. The electrode according to claim 10, wherein a thickness of the underlying substrate is from 2 μm to 1000 μm, and a thickness of the carbon film is from 5 nm to 500 nm.

17. The electrode according to claim 10, wherein a thickness of the underlying substrate is from 20 μm to 500 μm, and a thickness of the carbon film is from 10 nm to 300 nm.

18. An electrochemical measurement system comprising the electrode according to claim 1.

19. The electrochemical measurement system according to claim 18, wherein the electrode is constructed as a working electrode for stripping voltammetry.

20. The electrochemical measurement system according to claim 19, further comprising:
a reference electrode;
a counter electrode; and
a potentiostat constructed to control potentials of the working electrode, the reference electrode and the counter electrode.
